(19) United States
(12) Patent Application Publication
(10) Pub. No.: US 2015/0208613 A1
(43) Pub. Date: Jul. 30, 2015

(54) DOG RUNNING APPARATUS

(71) Applicant: Christopher KRASILCZUK, Ottawa (CA)

(72) Inventor: Christopher KRASILCZUK, Ottawa (CA)

(21) Appl. No.: 14/168,984

(22) Filed: Jan. 30, 2014

(51) Int. Cl. A01K 27/00; A01K 1/04

(52) U.S. Cl. CPC A01K 27/003; A01K 1/04

(57) ABSTRACT

An apparatus for running, exercising, leading or walking a dog comprising an arc bar having two ends, each end comprising an extendable cord extending from inside the arc bar and terminating in an attachment means, the extendable cord biased in a retracted position inside the arc bar and a retention member attached to the extendable cord distal from the attachment means which acts to limit extension of the extendable cord outside the arc bar and prevents transfer of force to the extendable cord on the other end of the arc bar. The present apparatus enables a dog to run within a defined range of a person or bicycle while limiting transfer of force from one side of the apparatus to the other during use.

### FIELD OF THE INVENTION

This patent relates to an apparatus for running, exercising, leading or walking a dog. Specifically, the presently described apparatus can be used to nm or walk a dog attached to a vehicle, such as a bicycle, or to a person.

### BACKGROUND

Running is an inherent characteristic of most dog breeds and it can be argued that it is what dogs live for. Having the ability and the time to nm a dog is extraordinarily difficult for many urban dog owners because of on leash by-laws in most public spaces. In addition, the time crunch experienced by many dog owners limits the time available to get in a good nm with their dog. As a consequence, many dogs that were bred or born to be active. i.e. running dogs, now spend the majority of time curled up on beds, couches, floors or crates. Breeds such as hounds, terriers, retrievers, pointers, setters and poodles etc. require a great deal of exercise to remain healthy and happy. Without enough exercise, the dogs we love can get fat, lazy, sick, and develop difficult behavioural problems.

Cycling and running is a great way for people to exercise, as well as to exercise their dogs at the same time. Such shared exercise brings mental and physical benefits to the person as well as the dog, and results in a stronger bond between the person and the dog. However, running or cycling with a dog can be challenging. Cycling with a dog on a standard lead can be dangerous, as dogs can get tangled in bike parts by coming too close to the bike. Holding a standard leash while biking can also be extremely dangerous because the riders attention is distracted from the road or trail and the dog will ultimately control the person if they divert from the path intended by the person whether by distraction, diversion or the need to stop.

U.S. Pat. Nos. 7,013,840 and 8,544,420 by Leon describe a dog leash for attachment to a bicycle or personal carrier having a stiffener and a mast connected to a clamp by a flexible coupling. This dog leash comprises a clamp or universal mounting bracket, a flexible coupling, a hollow, rigid, semi S-shaped mast, and an elongated cord, as well as a stiffener which is built up on a leading segment of the cord and which protrudes outwardly from the outer end of the mast. The clamp anchors the dog leash to a bicycle frame near a low point thereon or to a mounting bracket mounted to the frame. In this way, the dog can be retained at the same position beside a bicycle or personal carrier for the duration of the attachment of the dog to the device. The clamp is mounted directly on the frame of a bicycle or carrier using bolts and hand tightened nuts.

Similarly, U.S. Pat. No. 6,148,772 to Keyek-Frannsen describes a dog exercising/walking device for mounting to a bicycle which includes a mounting bracket having portions that engage and retain the device to the frame of a bicycle and a stationary bar extending laterally away from the mounting bracket comprising a ring for attachment to a harness or lead strap of a dog. This device is mounted adjacent to lowermost portion of a bicycle frame near the rear wheel mounting flange. Keyek-Frannsen further teaches that a low mounting position is important because the low position of the lead decreases the effective moment of the arm and increases the amount of force or pull by the dog necessary to pull the bicycle during use.

A leashed dog running alongside a person can alternate from one side of a person to the other, as well as change its distance from the runner. This can be disconcerting to the runner and dangerous to both dog and runner, as the dog can inadvertently collide with the runner, or run in front of the runner causing a standard leash to be stepped on or tripped over. When a person has the leash in their hand, they can direct the position of the dog during the run, however this can be inconvenient to the runner because it restricts arm mobility. This problem is compounded when the runner is attached to the dog via a belt because the runner can not immediately direct the positioning of the dog in an urgent situation.

U.S. Pat. No. 8,413,613 to Smith describes a pet leash comprising an arm band fixture connected to a user's arm to operate the leash hands free. The length of the leash can be adjusted for different user arm lengths and for different dog heights. Similar belt-type hands free dog leashes are described in Unites States Patent Application Publication Nos. US 2013/0042819 to Ekstrom and US 2013/0042818 to Capoano.

There remains a need for an apparatus that can be used for running and cycling with a dog which maintains the dog at a safe distance from the runner or rider and prevents injury to the dog and runner.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an apparatus for running, exercising, leading or walking a dog. The apparatus can be attached to a vehicle, such as for example a bicycle, or to a person by way of a belt or strap.

In accordance with one aspect, there is provided an apparatus comprising an arc bar having two ends, each end comprising an extendable cord extending from inside the arc bar and terminating in an attachment means, the extendable cord biased in a retracted position inside the arc bar, and a retention member attached to the extendable cord distal from the attachment means which acts to limit extension of the extendable cord outside the arc bar and prevents transfer of force to the extendable cord on the other end of the arc bar.

In accordance with one embodiment, the arc bar is hollow.

In accordance with another embodiment, the arc bar has a circular cross section.

In accordance with another embodiment, the extendable cord is a tension cord.

In accordance with another embodiment, the retention member is a retention ball.

In accordance with another embodiment, the extendable cord at each end of the two ends of the arc bar are the same extendable cord.

In accordance with another embodiment, the arc bar comprises ABS tubing or carbon fibre polymer tubing.

In accordance with another embodiment, the attachment means is a hook with a levered opening biased in a closed position.

In accordance with another embodiment, the apparatus further comprises reflective material and/or lights on the arc bar and/or retention member.

In accordance with another embodiment, the apparatus further comprises grip means positioned on one end of the arc bar.

In accordance with another embodiment, the extendable cord is pre-tensioned inside the arc bar.

In accordance with another embodiment, the apparatus further comprises a harness or collar for attachment to a dog.

In accordance with another aspect, there is provided a dog running apparatus comprising: a hollow arc bar; a tension cord extending through the hollow arc bar, each end of the tension cord terminating in an attachment means; two retention members, each retention member attached to the tension cord adjacent the hollow arc bar and acting to limit extension of the tension cord to prevent transfer of force to the attachment means on the other end of the arc bar.

In accordance with another embodiment, the arc bar is made of a semi-rigid material.

In accordance with another embodiment, the arc bar has a circular cross section.

In accordance with another embodiment, the arc bar comprises ABS tubing carbon fibre polymer tubing.

In accordance with another embodiment, the two retention members are retention balls.

In accordance with another embodiment, the apparatus further comprises reflective material and/or lights on the arc bar and/or retention members.

In accordance with another embodiment, the apparatus further comprises grip means positioned adjacent at one end of the arc bar.

In accordance with another embodiment, the apparatus further comprises a harness or collar for attachment to a dog.

In accordance with another embodiment, the attachment means is a hook with a levered opening biased in a closed position.

### BRIEF DESCRIPTION OF THE FIGURES

For a better understanding of the present invention, as well as other aspects and further features thereof, reference is made to the following description which is to be used in conjunction with the accompanying drawings, where:

FIG. 1A is a side view of one embodiment of the apparatus with a cut out section at the arc bar;

FIG. 1B is a is a side view of the embodiment of FIG. 1A showing the extension of one the extendable cords when force is applied.

FIG. 1C is a side view of one embodiment of the apparatus with exemplary dimensions;

FIGS. 2A-C are side cross-sectional views of various embodiments of the apparatus:

FIGS. 2D-2F are exploded side cross-sectional views of various embodiments of the apparatus;

FIGS. 3A-C depict the side view of various embodiments of the arc bar configuration:

FIG. 4A depicts the dog running apparatus attached to a standard bicycle and a dog;

FIG. 4B is a close-up of a bicycle seat attached to an attachment means of the apparatus;

FIG. 5A depicts a runner or walker wearing a belt, with the apparatus attached at one end to the belt and the other end to a dog, and FIGS. 5B and 5C is a photograph of the apparatus in use with a bicycle;

FIGS. 6A and 6B depict the apparatus attached to a bike on a cambered trail with a dog running higher than the bicycle (6A) and lower than the bicycle (6B), respectively.

### DETAILED DESCRIPTION OF THE INVENTION

### Definitions

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the feature or list following is non-exhaustive and may or may not include any other additional suitable features or items, for example one or more further feature(s), component(s) and/or material(s) as appropriate.

The term “vehicle” as used herein refers to an object for transporting people or goods. Non-limiting examples of vehicles that can be used with the present apparatus are a bicycle, tricycle, adult tricycle, wheelchair, power chair, scooter, power scooter, Segway™, stroller, or all terrain vehicle. Preferably, the vehicle is a type of bicycle, such as, but not limited to a road bicycle, cruiser style bicycle, BMX bicycle, mountain bicycle, snow bicycle, three wheeled bicycle, hybrid bicycle and recumbent bicycle.

The term “person” as used herein refers to a human using the device to run or walk a dog. The person can be a rider of a personal carrier such as a bicycle, wheelchair or other vehicle, or in non-vehicle-assisted locomotion such as a runner or walker.

The term “running” as it relates to exercising a dog means any perambulatory exercise or activity undertaken by the dog while the dog is attached to the described apparatus. At a slower person walking or riding pace, the dog may walk or trot, whereas at a faster person running pace or biking pace, the dog will be running. Also referred to as “leading” or “walking” a dog.

The term “dog” as used herein is used generally to describe the animal being lead, walked or run using the apparatus. In an urban setting, the apparatus will be most applicable for use with a dog, however it is understood that the same may be used with any animal that can be led using a leash by a person or personal carrier. The present device can be used with an animal any time a person wants to lead the animal at a restricted distance from the person. These may include farm animals, zoo animals, or wild animals.

The term “attachment point” as used herein refers to the location on the person, vehicle or dog where the attachment means at each end of the apparatus attaches to. It is understood that the present apparatus will have a person-side attachment point and a dog-side attachment point. In embodiments where the apparatus is symmetrical, either end of the apparatus can be attached at each of the two attachment points. Non-limiting examples of the dog-side attachment point can be a collar, muzzle or harness. When the apparatus is being used by a person walking or running, the attachment point can be, for example, a belt or belt loop, harness, bracelet, hand-held grip means such as a loop or handle, or appendage strap. When the apparatus is being used with a bicycle, the attachment point will preferably be somewhere on the bicycle, more preferably on a seat rail or post. Attachment to the seat rail is functional but also strategic in that it places the pull point just below the rider's center of gravity. The attachment point may also be elsewhere on the bicycle, such as on the frame, or on the rider. When the apparatus is being used with a vehicle other than a bicycle, the person-side attachment point can be anywhere on the vehicle that is convenient for the person using the vehicle, and prevents the dog from crossing in front of said vehicle or into its moving or fixed parts.

As used herein, the term “extendable cord” refers to a cord which can extend from inside the arc bar, increasing the cord length as measured from the attachment means to the end of the arc bar from which the cord is extending. The extendable cord can itself have elastic properties, and be comprised of tension cord. Alternatively, the extendable cord can be functionally coupled to a biasing member which biases the cord in a retracted position inside the arc bar. The cord will also have limited extension between the retention member and the attachment means.

The present apparatus comprises an arc bar, each end of the arc bar housing an extendable and retractable cord with an attachment member which is easy to attach to a belt, vehicle or bicycle at one end and a dog collar or harness at the other end. The arc bar has a curve in it as it drops away from its attachment point. The light weight nature of the apparatus permits the dog to run free without adding a burdensome weight to the neck of the dog or to the runner or rider. The result is a hands free, safe and effective lead for running a dog. Except for when the rider or runner wishes to direct the dog to a particular side of the person, the apparatus operates entirely hands free, leaving the hands of the rider to focus on steering and the runner a full range of motion. The apparatus limits the distance range of the dog from the vehicle or person and maintains a safe minimum distance between the dog and the vehicle or person. Streets and trails are not perfect environments, and there are changes in slope, hazards, impediments, and environmental conditions to which the dog and person must respond. A rigid and/or fixed connection between person and dog can create a serious risk of harm to the dog and rider. Because the present device permits a wide range of motion for the dog about the person from the attachment point, both in the running plane as well as in the vertical direction, the present apparatus permits the dog a free range within a prescribed arc.

The attachment point, length, curvature, durability and smooth surface of the arc bar permit it to cross over the rear tire of a bicycle regardless of tread design without any impediment to the dog or bicycle. This allows the dog to naturally move out of the way of oncoming obstacles and closely track the path of the bicycle. Tests of the apparatus have proven that the dog will typically run on the side of the bicycle selected by the rider and the dog quickly adapts to the range it has and instinctively adjusts its position based on upcoming obstacles.

Of course, there remain risks to running or riding with a dog, but these are mitigated by the dog and rider's capacities to react independently of one another within a prescribed range. For example, during a bicycle ride when approaching a tree or narrow passageway, the present apparatus permits the dog to retreat behind the bike and return to the side of the bike once the obstacle has been passed. Stationary devices attached to the frame of a vehicle or bicycle do not permit this degree of movement and would require the cyclist to divert course or stop entirely. The present apparatus gives the dog almost a complete range of motion including moving away to the range limits of the apparatus or towards the rider, as well as forwards to the range limits of the apparatus without enabling the dog to run in front of the vehicle. In addition, the dog's movement is not restricted, enabling the dog to duck low lying objects such as branches or overhangs as well as leap over obstacles on the ground such as branches, stumps, rocks, holes etc.

With the apparatus, a dog can be safely run around the neighbourhood in 10 to 15 minutes when attached to a bike or vehicle, covering substantially more distance than can be accomplished on foot. This gives the dog and rider needed exercise, is convenient to the person, and saves time to the person. The apparatus also permits the person, whether on foot or on the bicycle, to regulate the dog's pace from stationary to walk, to trot, to a full nm. Ease of installation further decreases the barrier to use for the person.

The role of the extendable cord is to provide each of the person and dog with an extendable and retractable lead which can absorb shock and pulling forces caused by sudden changes in tension, and generally sudden changes in distance and direction from the attachment means to the arc bar. The extendable cord performs two main purposes: to provide a lead from person to dog; and to absorb and reduce the effects of unanticipated or rapid movements of the dog and person. Pulling or jerking action of the extendable cord on each side of the arc bar thus minimizes shock or force transfer and sudden or jerky forces to the attachment point on the other size of the arc bar. For example, tension applied to the extendable cord on the dog side is counteracted by the retention member, while minimizing the force transferred to the part of the tension cord between the person attachment point and the person side of the arc bar. In use, if the dog suddenly jerks to avoid an obstacle, the extendable cord on the second side of the arc bar can expand to give the dog additional lead while absorbing the movement to avoid a reciprocal movement to the person. Similarly, the extendable cord on the other side of the arc bar can expand if the rider makes a sudden swerve, limiting the amount of sudden pull that the dog experiences to accommodate the swerve. The present apparatus can function without extendable cords on both distal ends, but at the expense of limiting absorption of forces for the dog and rider. An extendable cord at both of the vehicle/person end and the dog end are preferable for the functioning of the apparatus for the following reasons: (1) by having both ends extendable the apparatus is able to absorb sudden pulls and jerks independently: and (2) large pulls or jerks will cause the extendable cord to extend to its limits on both sides.

Safety of the dog is important, especially when running alongside or behind a bicycle. The present apparatus keeps the dog away from the moving parts of the bicycle, such as the wheels, pedals, gears, chain, handlebars and forks. The dog is allowed to run at a safe distance from the rider or runner and can set a more natural pace, going from a walk to a trot to a run on its own terms. The rider is also able to observe the dog's performance during the moments when it runs in the space approximately covering the distance between the front axle and the area approximate to the rear tire. The person is also able to sense when the dog is slowing behind the rear wheel because of the tensioning of the extendable cord by way of pull on the apparatus. The effective length of the apparatus restricts the dog front going ahead of the bicycle or between the front tire and the down tube.

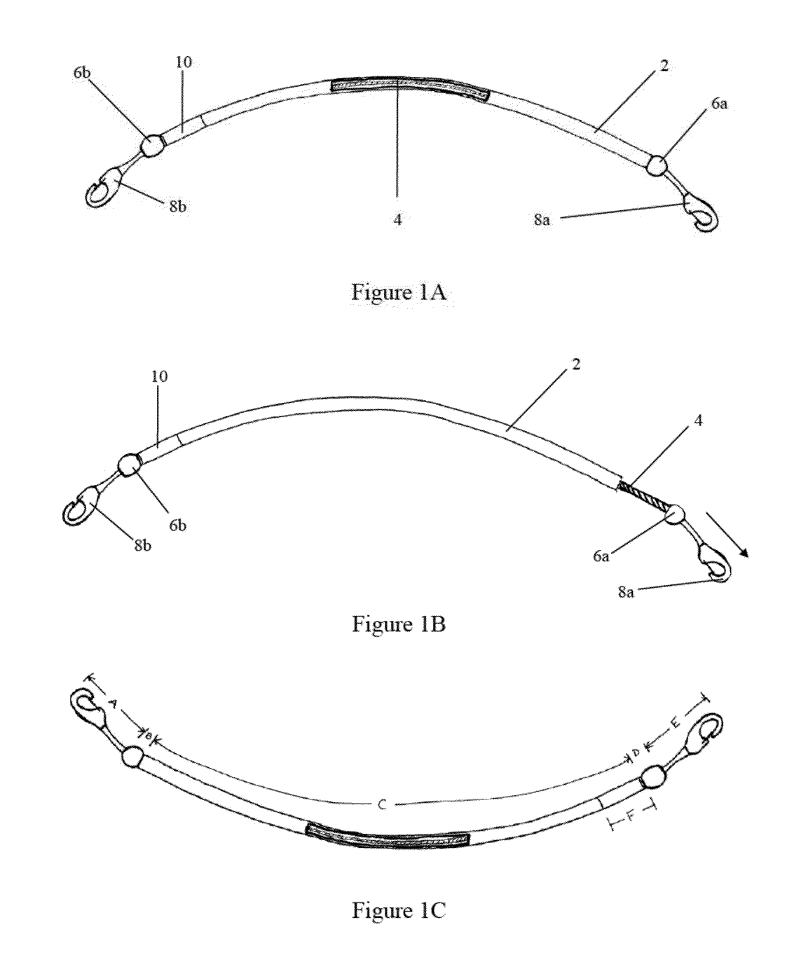

Turning now to the embodiment shown in FIG. 1A, the arc bar (2) comprises a hollow tube capable of receiving the extendable cord (4). The arc bar serves to maintain a minimum distance between person and dog while having a reasonable weight that is not burdensome to either person or dog. The arc bar fundamentally serves a number of purposes: to keep the lead from tangling itself on the rider, bicycle or dog; to deflect the lead off the rear tire; to transfer the lead from one side of the rear tire to the other and to keep the dog within a specified range. The arc shape of the arc bar enables the apparatus to be easily manipulated by the person to direct the position of the dog relative to the person-side attachment point.

In the embodiment of FIG. 1A, extendable cord (4) is a tension cord and is positioned through the inside of hollow arc bar (2). The arc bar is shown cut away in the centre to reveal the extendable cord (4). In this embodiment, a single contiguous length of tension cord is positioned between the person attachment end and the dog attachment end. Retention members (6a, 6b) are shown in FIG. 1A as retention balls, and are attached to the extendable cord (4) at either end of the arc bar. Lateral movement of the tension cord through the hollow arc bar and extension of the extendable cord in the direction from which tension is applied is restricted by the retention members (6a, 6b). Each retention member functions to limit the extension of the tension cord on either side of the arc bar. In this way, the tension cord on each side of the arc bar acts generally independently of the other side and limits the amount of force experienced on one side of the arc bar when tension is applied to the other side. In the embodiment shown in FIG. 1A, the retention members permit pre-tension to be applied to the tension cord between the two retention members which assists in retaining the curvature of the arc bar. This also pulls the retention members (6a, 6b) against and seals the open ends of the hollow arc bar. The retention members (6a, 6b) in the embodiment shown in FIG. 1A can be a knot in the tension cord, a retention ball, or combination thereof. In one embodiment, the retention member is a knot in the tension cord encased in a protective cover. The protective cover further prevents the knot from regressing into the arc bar when pressed up or pulled against the opening of the arc bar. Preferably, the retention member is a retention ball. Preferably, the retention member is free to swivel and rotate with the natural flexibility of the retention cord. This can be achieved either by means of a swivelling and/or rotating attachment between the retention member and the extendable cord or by means of a retention ball.

Attachment means (8a, 8b) are shown at either end of the arc bar for attaching to the dog and vehicle or person, respectively. The retention member (6b) for the dog attachment means (8a) is positioned at the person attachment end of the arc bar so that force applied from the dog attachment means (8a) can enable the dog end of the extendable cord to absorb most of the shock applied by the dog while transferring minimal pull to the person through the person attachment end.

FIG. 1B shows the extension of the extendable cord (4) on the dog attachment end of the arc bar when force is applied to the dog attachment means (8a). The tension cord is shown in an extended position, and the retention member on the side of apparatus in which the cord is being extended is pulled away from the arc bar. In this way, the attachment means on the opposite or person side of the arc bar therefore is not affected by tension applied on the dog side of the arc bar. If the vehicle or person suddenly moves away from the dog, the extension of the cord and absorption of shock is initiated at the person attachment point to the person attachment means (8b) as the retention member at the dog end (6a) presses against the dog end of the tubular arc bar. When the pulling force is applied by both the vehicle/person and the dog, the range of the extendable cord is maximized to its stretch limit, which is limited so as to prevent the dog from getting in front of the bicycle. Optional grip means (10) is placed on the vehicle or person side attachment point.

FIG. 1C shows one exemplary embodiment of the apparatus with exemplary dimensions, summarized in Table 1. This embodiment is exemplary only and provided only for the purpose of demonstrating one possible embodiment. It would be understood to the skilled person that the dimensions of the elements of the apparatus may be modified, as discussed herein, without departing from the scope of the present invention.

In this embodiment, the diameter of the arc bar is 1″ and the tension cord is a ⅜″ diameter shock cord. The total untensioned length of the tension cord and attachment means is 43″, and the length of the tension cord unstretched between the retention balls is 33″.

TABLE 1

| | | Dimensions |
|---|---|---|
| Feature | Element | (feet, inches) |
| A | end of attachment means to retention member, | 7″ |
| | dog side | |
| B | retention member (ball) | 1½″ |
| C | arc length of arc bar | 3′ 2″ |
| D | retention member (ball) | 1¼″ |
| E | end of attachment means to retention member, | 6″ |
| | person side | |
| F | grip means | 3½″ |

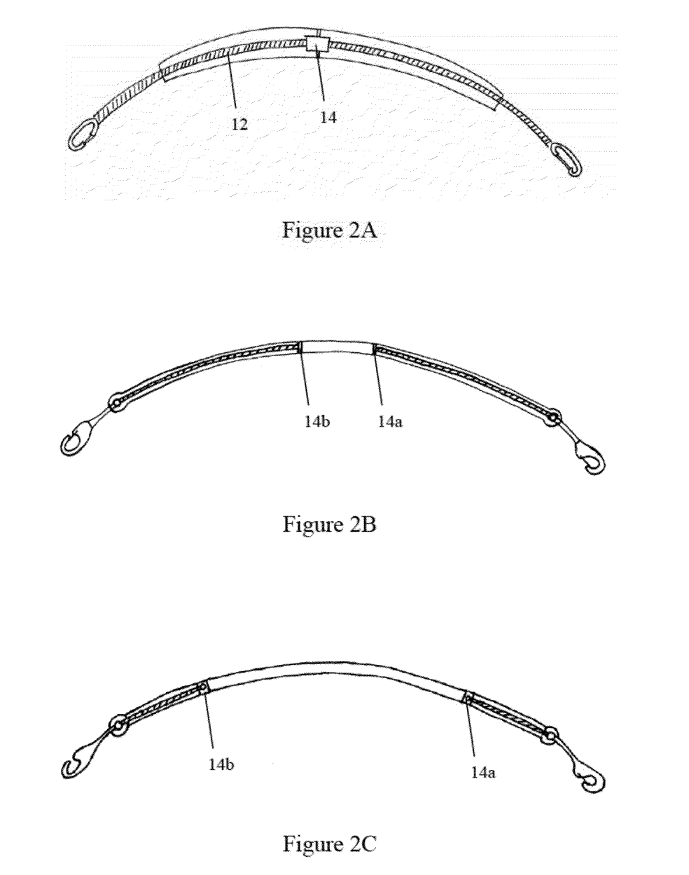

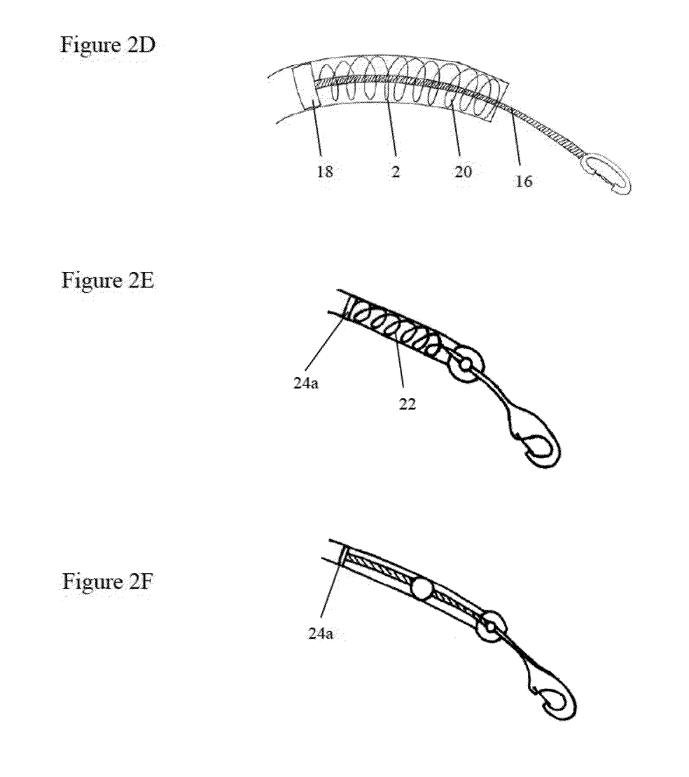

In other exemplary embodiments, shown in FIGS. 2A-2F, the arc bar (2) may be hollow or solid, or have a combination of hollow and solid features. In the embodiment in FIG. 2A, the apparatus comprises a tension cord (12), a static retention member (14) which serves as a single retention member statically positioned inside the arc bar. Extension of the tension cord (12) on either side of the arc bar is limited by the static retention member (14). The embodiments shown in FIGS. 2B and 2C each have two static retention members (14a, 14b).

In the embodiment shown in FIG. 2D, the extendable cord (4) can be a static cord (16) attached to a dynamic retention member (18) which can slide along the length of the inside of a hollow part of the arc bar (2). A biasing means, shown as spring (20), limits extension of the static cord (16) outside the arc bar and is able to absorb force exerted by the dog or rider through the attachment means. Non-limiting examples of biasing means can be a steel spring or foam spring.

In the alternative embodiments shown in FIGS. 2E and 2F, spring (22) is made of metal or elastomer, or other material with similar compressive properties, and can be positioned near the ends of the arc bar. The spring can be attached to a static or non-static cord (tension cord) which is further connected to an additional retention member (24a). The extendable cord system comprises a cooperatively attached spring and cord. In another embodiment, the arc bar itself can have an extendable and compressible component at its end capable of stretching under a pulling force.

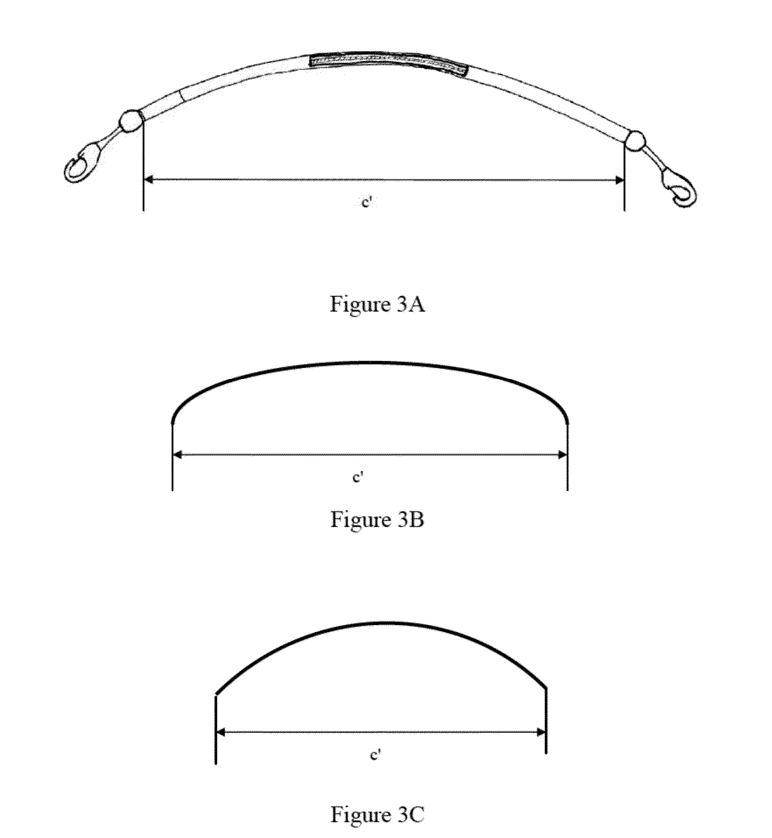

The arc bar has at least one portion that is arcuate in shape. In one embodiment shown in FIG. 3A, the arc bar has a natural arc or circumference comprising a single arc. The arc length of the arc bar, shown as (C) in FIG. 1C, is slightly more than the end-to-end distance of the arc bar in a curved position. In the embodiment shown in FIG. 3A, the end-to-end length of the arc bar (c′) is approximately 85% of the arc length of the arc bar. Preferably, the end-to-end length of the arc bar (c′) is about 75-95% of the overall straight length or arc length (C) of the arc bar. More preferably, the overall end-to-end length of the arc bar (c′) is about 85% of the arc length (C) of the arc bar. The arc shape of the arc bar also limits swivel and rotation of the apparatus.

The end-to-end length (c′) of the arc bar should exceed the distance from a standard adult bicycle seat to the beyond the end of the back tire. The arc bar may also be telescopically adjustable in length, for example by means of a pin fitting. The arc bar may also be foldable, for example by means of locking joints along its length, in order to be stored or carried. In this way, a dog can move from one side of a bicycle to the other side, while bypassing and keeping a safe distance from the back tire, but remaining a safe distance from the leading edge of the front tire and the space that exists between the front tire and the bicycle frame down tube. Field trials recorded on video demonstrate that a dog without a lead essentially runs in the same distance range of the present apparatus, with the dog naturally adjusting to the position of the bike/rider on a narrow trail. This provides a unique perspective into dog behaviour and illustrates how close a dog will naturally run next to its pack, i.e. the rider it is following, without getting in the way.

In another embodiment shown in FIG. 3B the arc bar has a generally straight middle section and with an arcuate section at either end. The arc bar may also have a progressively greater or regressively smaller curve where the curve either increases or decreases away from the attachment points. The upper portion of the arc bar may have a steeper curve shown in FIG. 3C which then leads into a consistent curve to the attachment point. There may also be compound curves where the curve at the top is moderate, the middle greater and the ends being of a greater degree than that in the middle.

Preferably, the arc bar has a circular cross section without corners so that the arc bar is able to easily deflect off of a rear tire of a bicycle upon contact.

The arc bar is made of a rigid or semi-rigid material that generally retains its shape to limit the movement of the dog to a radius around the person-side attachment point of the apparatus. The arc bar is also preferably made of a durable material that is able to withstand repeated contact with a bicycle tire. Some non-limiting examples of materials for the arc bar include durable polymer tubing, such as, for example, acrylonitrile butadiene styrene (ABS) tubing, carbon fibre polymer tubing, and metal tubing such as, for example, aluminum tubing. A semi-rigid arc bar can also adopt a less curved shape during use to absorb additional force. Semi-rigid plastic or composite piping allows some flexibility of changing the degree of arc without compromising the strength of the arc bar. The combination of the integral curve of the arc bar and the semi-rigid material provides inherent flexibility to the arc bar, but not to the point of collapse or folding over. The extendable cord can also be pre-tensioned inside the arc bar between the two retention members which can serve as pre-load for the cord and an aid in retaining the desired arc of the arc bar.

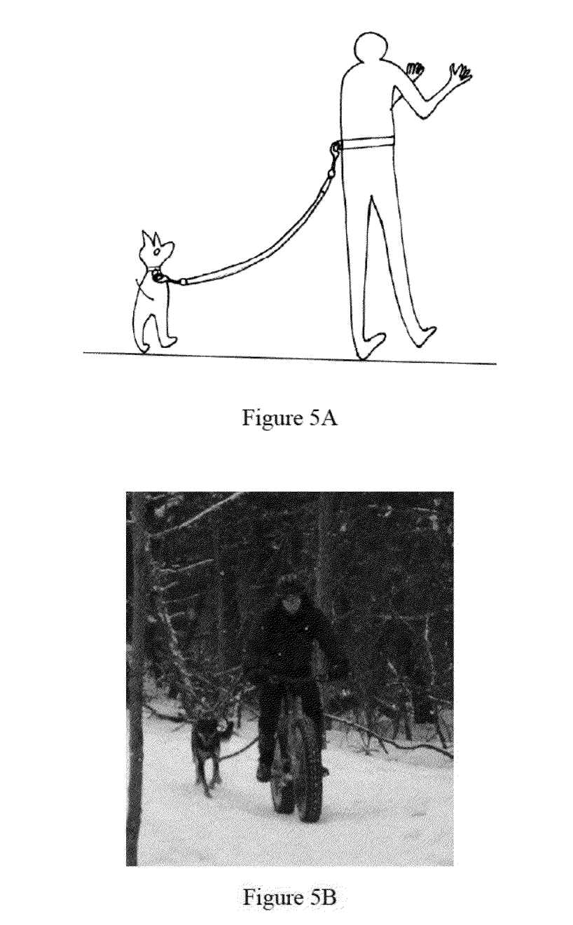

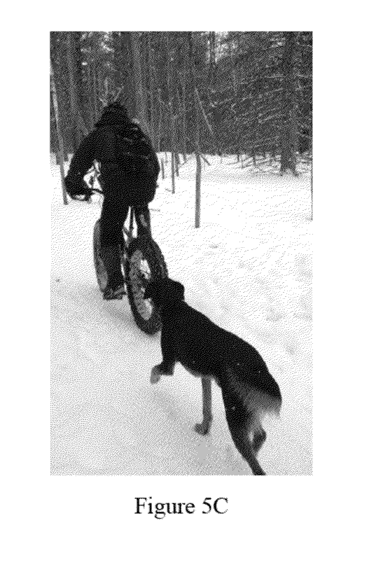

The diameter and curve of the arc bar allows it to easily transfer/roll over the rear tire of a bicycle without binding or catching regardless of the tread design of the tire. This interaction between the arc bar and the rear tire of a bicycle is exemplified in FIG. 5C. An arc bar with a continuous arc around the back and side of the bicycle or runner assists in smoothly deflecting the arc bar away from or around the rear tire of a bicycle, or around the body of a runner, when in motion. A rider can also direct the dog to change sides of the bicycle or person by rolling or rotating the arc bar along its longitudinal axis, for example over the back tire, optionally gripping a handle or grip means, all the while keeping the dog away from the tire. By gripping the arc bar near the person side attachment point and rotating the arc bar, a rider or runner can direct the dog to change positions from one side of the bicycle or runner to the other. Rotation and/or horizontal translation of the arc bar thereby gently directs the dog to move in the direction of the rotation of the arc bar. In addition, the smooth surface, flexibility and low weight of the arc bar permits it to deflect off the rider/runners hips and legs without discomfort.

The arc bar can also comprise optional grip means (10) positioned adjacent the person attachment end of the arc bar for ease of the person to grip the arc bar to direct the position of the dog. The grip means provides a location for the person to hold while moving the arc bar into a more suitable position. Grip means includes any material or feature that increases the friction at one end of the arc bar to enable a person to more easily grip the arc bar. Non-limiting examples of grip means include, for example, grip tapes or adhesives, and texturing on the arc bar such as raised or inset stripes or lines, stippling, or any type of inset or raised feature that improves grip. Grip means also includes any physical feature that improves the ability of a person to hold onto or grip the arc bar. Non-limiting examples of such physical features include applied foam tapes or tubes, rubber tapes or tubes, handles, knobs, loops and one or more holes in the arc bar. The optional grip means can improve the rider or runner's grip on the arc bar and ease the rotation of the arc bar relative to the person-side attachment point.

The arc bar and/or retention members can also comprise additional safety features to make the apparatus more visible. For example, light emitting diode (LED) lights can be attached to or embedded in the arc bar and/or retention members for improved night-time visibility. The arc bar and/or retention members can also be manufactured from optically attractive or reflective materials, or can be adorned with such materials to improve daytime and/or night-time visibility. These materials include fluorescent materials and paints, glow in the dark or luminescent materials and paints, adhesive tapes and stickers, and any other material that improves visibility. The same or similar features can be added to the extendable cord and attachment means of the apparatus.

The extendable cord allows the dog and rider some limited additional extension along the length of the apparatus. By applying tension to the extendable cord on either or both of the extendable cords the rider and/or dog can quickly adapt to environmental challenges such, for example, vehicles, pedestrians or road or trail conditions while limiting the pulling applied force to the other. The extendable cord on either side of the apparatus can thus absorbing sudden pulls from the dog or rider in order to reduce the strain on the collar or harness worn by the dog and to reduce sudden movements to the runner or rider.

One type of extendable cord that can be used is tension cord, also commonly referred to as shock cord or bungee cord. Various types of tension cord are available, such as solid rubber cord and stranded rubber cord, both of which can optionally be enclosed inside a flexible woven, braided or webbed material. Generally, a tension cord comprises one or more elastic cords or fibres each composed of one or more elastic strands forming a round or flat core. The core is preferably covered in a woven cotton, nylon, polyester or polypropylene sheath. Some non-limiting examples of suitable tension cords are polyester or polypropylene (bungee) cord comprising either a single rubber fibre or multiple rubber fibres. Various widths of bungee card are available such as ⅛, 3/16, 7/32, ¼, 3/16, ⅜, ½ inch diameter widths and can be used singly or multiply to provide the desired tension. Other types of tension cords are flat elastic or braided webbing in various widths ranging from ½ inch to1½ inch. Preferable maximum extension of the extendable cord is about 15% of the original resting length of the cord. The extendable cord must be able to absorb sufficient tension to enable stretching while being strong enough to substantially maintain a safe distance between the person and the dog.

Most city bylaws require that a dog be on leash, or restrained by a person holding a leash attached to the dog's collar or harness, at all times when in public spaces. Keeping the dog within a specified range while still allowing the rider and dog to be in their normal riding and running behaviour is important for the safety of the dog and person. In an urban or congested setting while riding, if the dog were to dart off it could lead to potential danger for the dog, passersby, cars etc. With the dog attached to the apparatus, the dog is permitted to run relatively freely and naturally until it reaches the inherent limits of the apparatus, cueing it to return to the rider's side or behind the bike. One preferable attachment means of the present apparatus is a closeable hook which can be securely attached at each of the person or dog attachment points and is not removable by the dog. One preferable attachment means is a caribiner-style hook having a hook with a levered opening biased in the closed position.

One method of attaching the apparatus to a bicycle is by means of a bracket, which can be affixed under the seat, preferably to the seat rails or post. The bracket optionally comprises a rotating plate to which a short extension arm is attached with an attachment ring at its end. Preferably, the attachment means simply clips onto the seat rail or other location on the bicycle or vehicle for easy install and release of the apparatus from the vehicle and does not require any tools to open or close. A quick release attachment such as a closeable hook eases attachment to the person attachment point and dog attachment point and therefore saves time and allows quick and reliable connection.

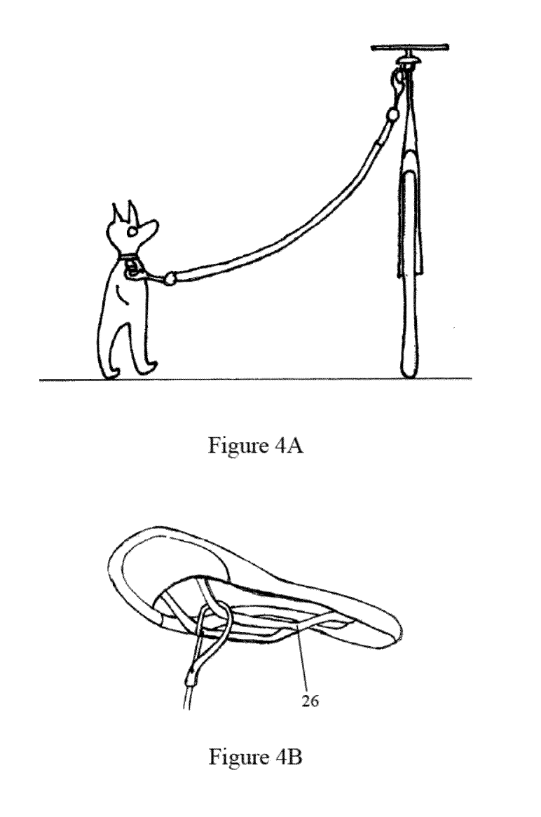

The attachment means can be manufactured from any material strong enough to withstand the pressures of use of the apparatus without breaking. It is further preferable that the attachment means be made of a material that will not cause damage to the person or dog attachment point. For example, closeable hooks made from durable polymer, reinforced plastics such as fibreglass reinforced plastics, coated carbon fibre or coated aluminum will cause little or no damage to any frame material or finish as it is not mounted to the frame or bike parts. Preferable attachment means are made from high strength plastic/composite materials with a high tensioned stainless steel or aluminum closing bar for quick release attachment. Non-limiting examples of attachment means includes non-locking carabiners, locking carabiners such as screw-lock, cam-lock, hook and catch, loop and hook/catch, or any positive connection within a channel that requires the closing mechanism to be snapped into place. An embodiment of this type of attachment is shown in FIG. 4A attached to the collar of a dog and to the seat rail of a bicycle, in close-up FIG. 4B shown attached to the seat rail of a bicycle, in photograph FIG. 5B and in FIG. 5A attached to an attachment point on a runner or walker.

When used with a bicycle, as shown in FIG. 4A, the attachment point of the apparatus on the person-side is preferably as close to the true center of gravity of the rider and bicycle as possible. A force acting at a point low on the bike and well below the centre of gravity, such as a sudden jerk from an attached dog, could be sufficient to destabilize the bike and put the rider and dog at risk of injury. Attachment of the dog to a bicycle at a higher position, closer to the centre of gravity of the bicycle and rider, enables the rider to better adjust to tension on the arc bar from the dog and reduce the risk of destabilizing effects on the bicycle. This further allows greater mobility to the dog without causing additional risk to the rider.

The centre of gravity of a person when cycling is near the seat on virtually all standard bicycles. Therefore, it is preferable that the attachment point of the apparatus be somewhere near the seat. Bicycle seats or saddles have standard features that are common to most seats. A standard bicycle seat is shown in FIG. 4B, with one attachment means of the present apparatus attached around one of the seat rails (26). Because the majority of standard bicycle seats are supported by rails below the seat, a natural attachment point already exists. Field tests of the apparatus confirm the stability of attachment at this point. By placing the lead attachment at the seat rails the dog must pull the greatest amount of mass in order to break away from the bike/rider compared to designs that place the attachment point on the chain or seat stays at a position lower than the center of gravity and behind it thereby lowering the required force necessary for the dog to pull the bike out from underneath the rider. In all trials of the present apparatus, this attachment design has proven effective. Attachment of the apparatus at this point has been found to provide a stable and secure connection between the rider and dog.

Attachment at the dog end of the apparatus can be to the collar (as shown in FIG. 4A) or muzzle of a dog, or to a harness somewhere on the body of the dog. The collar or harness attachment should be sufficiently rotatable on the neck or trunk of the dog so that it does not interfere with movement of the dog during running. The present apparatus can also include a suitable harness or collar for attachment to a dog.

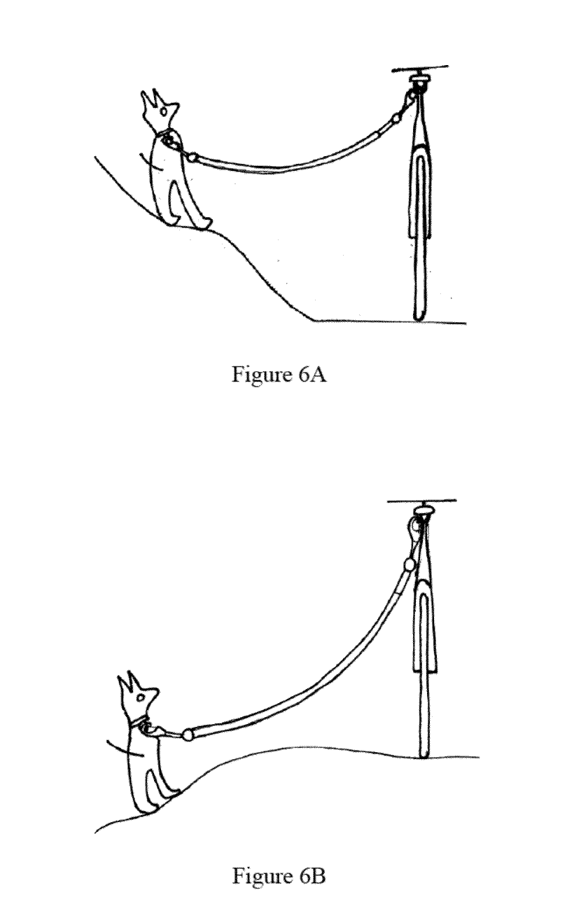

When cycling on a flat surface such as a road or sidewalk, shown in FIG. 4A, the dog and the rider are effectively at the same vertical position. As shown, the dog is maintained at a safe distance from the rider. However, shown in FIGS. 6A and 6B, on an uneven surface such as a trail ride, the vertical position of the running dog relative to the bicycle is not necessarily the same, as it is on pavement or in an urban setting. Also, on a trail, the vertical position of dog and rider can change dramatically and quickly. The present apparatus is able to adjust in a vertical direction to accommodate to the trail and results in greater mobility and versatility for the dog and rider. For example, in FIG. 6A, a dog is shown on the high side of a trail relative to the bicycle. In FIG. 6B, the dog is shown on the low side of the trail, with the apparatus able to compensate for the vertical position of the dog relative to the bicycle in both positions. The connected dog and rider are thus kept at a safe distance from one another so that sudden changes in direction causing tension on the extendable cord will be tempered, and the apparatus meanwhile is kept out of the way of the dog and person. Should a sudden force applied to a rider near the centre of mass at the seat, the rider can naturally accommodate by shifting his weight slightly.

Tests of the apparatus show that the dog adapts to the limited range of the apparatus without restricting its mobility. The present apparatus keeps the dog at a distance which simulates the distance at which many of the dogs who join us on rides off leash nm at, except for the fact that the apparatus limits the dog's range such that it cannot move in front of the bike or between the frame down tube and front tire. Because of the mobility at the attachment points, contact with the lower body runner or rider can occur during use. Human test subjects have indicated that this contact has neither been a impediment, hazard or nuisance. In biking, the gentle pressure experienced by the person signals the rider that the dog has closed its range between itself and enables the rider to then adjust their direction or speed. The initial reaction of the dogs tested is generally to pull away and forward from the attachment point. When frightened by an unexpected stimulus, the dog tends to run forward, pulling at the attachment point. In all cases when the apparatus was used with a bicycle, the dog quickly learned to run within an acceptable range. An attachment point at the seat took the attention of the lead away from the rider, enabling the rider to maintain their focus on riding rather than on the dog.

The present apparatus has been successfully tested with no damage to carbon fibre and titanium road bikes, full suspension mountain bikes made of steel carbon and aluminum, and hard tail mountain bikes made of steel and aluminium. Bicycles with wheel sizes of 16″, 20″, 26″, 650b and 700cc have also been tested with the present apparatus with no damage to the bicycle or rider, and no injuries to the dog. The present apparatus has also been successfully used by male and female riders ranging in age from 11 to 48 and has been well received with no injuries to any of the people or dogs.

The lightweight design of the present apparatus also limits the amount of extra weight carried by the dog and person, especially while running. Advantages during running compared to a standard leash are evident in the design. The apparatus can be hooked to a belt or belt loop and used by a jogger or runner to keep the dog at a distance from the runner's legs and control the dogs movements by hand when holding onto the lead. The apparatus can also be used in a hunting situation to keep the dog within a defined range of the hunter. Shown in FIG. 5A, the dog is kept at a safe distance from the runner and the apparatus prevents the dog from approaching the runner's legs. Because the lead is fully encased in the arc bar, there is no loose lead to become trapped in and around the body, arms or legs of the runner, or in the legs of the dog. This also allows the dog the greatest range of motion without putting it at risk of running into the runner or walker. The dog and leash are also thus kept off the ground and away from the runner's legs and feet and from the dog's legs and paws, reducing the chance of injury to both dog and runner.

All publications, patents and patent applications mentioned in this Specification are indicative of the level of skill of those skilled in the art to which this invention pertains and are herein incorporated by reference to the same extent as if each individual publication, patent, or patent application was specifically and individually indicated to be incorporated by reference.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims. The scope of the claims should not be limited by the preferred embodiments set forth in the Examples, but should be given the broadest interpretation consistent with the description as a whole.

The embodiments of the invention in which an exclusive property or privilege is claimed are defined as follows:

1. An apparatus for running a dog comprising:
an arc bar having two ends, each end comprising:
an extendable cord extending from inside the arc bar and terminating in an attachment means, the extendable cord biased in a retracted position inside the arc bar; and
a retention member attached to the extendable cord distal from the attachment means which acts to limit extension of the extendable cord outside the arc bar and prevents transfer of force to the extendable cord on the other end of the arc bar.

2. The apparatus of claim 1, wherein the arc bar is hollow.

3. The apparatus of claim 1, wherein the arc bar has a circular cross section.

4. The apparatus of claim 1, wherein the extendable cord is a tension cord.

5. The apparatus of claim 1, wherein the retention member is a retention ball.

6. The apparatus of claim 1, wherein the extendable cord at each end of the two ends of the arc bar are the same extendable cord.

7. The apparatus of claim 1, wherein the arc bar comprises ABS tubing or carbon fibre polymer tubing.

8. The apparatus of claim 1, wherein the attachment means is a hook with a levered opening biased in a closed position.

9. The apparatus of claim 1, further comprising reflective material and/or lights on the arc bar and/or retention member.

10. The apparatus of claim 1, further comprising grip means positioned on one end of the arc bar.

11. The apparatus of claim 1, wherein the extendable cord is pre-tensioned inside the arc bar.

12. The apparatus of claim 1, further comprising a harness or collar for attachment to a dog.

13. A dog running apparatus comprising:
a hollow arc bar;
a tension cord extending through the hollow arc bar, each end of the tension cord terminating in an attachment means;
two retention members, each retention member attached to the tension cord adjacent the hollow arc bar and acting to limit extension of the tension cord to prevent transfer of force to the attachment means on the other end of the arc bar.

14. The apparatus of claim 13, wherein the arc bar is made of a semi-rigid material.

15. The apparatus of claim 13, wherein the arc bar has a circular cross section.

16. The apparatus of claim 13, wherein the arc bar comprises ABS tubing or carbon fibre polymer tubing.

17. The apparatus of claim 13, wherein the two retention members are retention balls.

18. The apparatus of claim 13, further comprising reflective material and/or lights on the arc bar and/or retention members.

19. The apparatus of claim 13, further comprising grip means positioned adjacent at one end of the arc bar.

20. The apparatus of claim 13, further comprising a harness or collar for attachment to a dog.

21. The apparatus of claim 13, wherein the attachment means is a hook with a levered opening biased in a closed position.
